(19) United States
(12) Patent Application Publication
(10) Pub. No.: US 2016/0291956 A1
(43) Pub. Date: Oct. 6, 2016

(54) ACTIVE PEN REPROGRAMMING

(71) Applicant: SYNAPTICS INCORPORATED, San Jose, CA (US)

(72) Inventors: Kirk Hargreaves, San Jose, CA (US); Oscar Ayzenberg, San Jose, CA (US); Eric Wu, Santa Clara, CA (US)

(21) Appl. No.: 14/675,632

(22) Filed: Mar. 31, 2015

(51) Int. Cl. G06F 9/445; G06F 3/038; G06F 3/0354

(52) U.S. Cl. CPC G06F 8/65; G06F 3/03542; G06F 3/0386

(57) ABSTRACT

An active pen, including: a receiver configured to obtain a plurality of a reprogramming instructions from a reprogramming device; and a controller configured to modify software of the active pen based on the plurality of reprogramming instructions.

### FIELD

This invention generally relates to electronic devices.

### BACKGROUND

Input devices such as imaging sensors and touch screens are used in a variety of devices including, but not limited to, cell phones, tablet computers, laptop computers, monitors, televisions, handheld gaming devices, and many other devices. Inputs devices are able to detect a large variety of inputs, and use that information to perform many different functions. One such input may be received from an active pen.

### SUMMARY

In general, in one aspect, embodiments of the invention relate to an active pen. The active pen comprises: a receiver configured to obtain a plurality of a reprogramming instructions from a reprogramming device; and a controller configured to modify software of the active pen based on the plurality of reprogramming instructions.

In general, in one aspect, embodiments of the invention relate to a reprogramming device for reprogramming an active pen. The reprogramming device comprises: a reprogramming module configured to obtain a plurality of reprogramming instructions for the active pen; and an output device configured to transmit the plurality of reprogramming instructions to the active pen to modify software of the active pen.

In general, in one aspect, embodiments of the invention relate to a method of reprogramming an active pen. The method comprises: obtaining, by a reprogramming device, a plurality of reprogramming instructions; and transmitting, by the reprogramming device, the plurality of instructions to the active pen, wherein the plurality of instructions are received by a sensor on the active pen, and wherein the plurality of instructions modify software of the active pen.

Other aspects of the invention will be apparent from the following description and the appended claims.

### BRIEF DESCRIPTION OF DRAWINGS

FIG. 1 shows a schematic diagram of an input device in accordance with one or more embodiments.

FIG. 2 and FIG. 3 show schematic diagrams of an active pen in accordance with one or more embodiments.

FIGS. 4A-4D show circuit diagrams for an active pen in accordance with one or more embodiments.

FIG. 5 shows a flowchart in accordance with one or more embodiments.

### DETAILED DESCRIPTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Various embodiments of the present invention provide input devices and methods that facilitate improved usability.

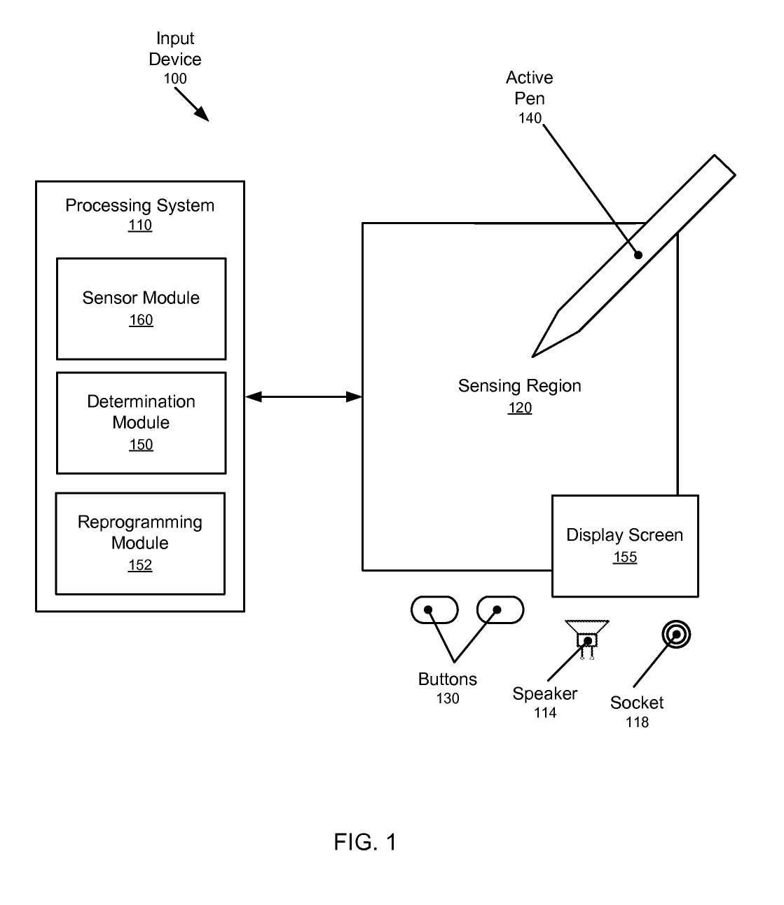

Turning now to the figures, FIG. 1 is a block diagram of an exemplary input device (100), in accordance with embodiments of the invention. The input device (100) may be configured to provide input to an electronic system (not shown). As used in this document, the term “electronic system” (or “electronic device”) broadly refers to any system capable of electronically processing information. Some non-limiting examples of electronic systems include personal computers of all sizes and shapes, such as desktop computers, laptop computers, netbook computers, tablets, web browsers, e-book readers, and personal digital assistants (PDAs). Additional example electronic systems include composite input devices, such as physical keyboards that include input device (100) and separate joysticks or key switches. Further example electronic systems include peripherals, such as data input devices (including remote controls and mice), and data output devices (including display screens and printers). Other examples include remote terminals, kiosks, and video game machines (e.g., video game consoles, portable gaming devices, and the like). Other examples include communication devices (including cellular phones, such as smart phones), and media devices (including recorders, editors, and players such as televisions, set-top boxes, music players, digital photo frames, and digital cameras). Additionally, the electronic system could be a host or a slave to the input device.

The input device (100) may be implemented as a physical part of the electronic system, or may be physically separate from the electronic system. Further, portions of the input device (100) as part of the electronic system. For example, all or part of the determination module may be implemented in the device driver of the electronic system. As appropriate, the input device (100) may communicate with parts of the electronic system using any one or more of the following: buses, networks, and other wired or wireless interconnections. Examples include I2C, SPI, PS/2, Universal Serial Bus (USB), Bluetooth, RF, and IRDA.

In FIG. 1, the input device (100) is shown as a proximity sensor device (also often referred to as a “touchpad” or a “touch sensor device”) configured to sense input provided by one or more input objects (e.g., fingers, active pen (140)) in a sensing region (120). Throughout the specification, the singular form of input object is used. Although the singular form is used, multiple input objects exist in the sensing region (120). Further, which particular input objects are in the sensing region may change over the course of one or more gestures. For example, a first input object may be in the sensing region to perform the first gesture, subsequently, the first input object and a second input object may be in the above surface sensing region, and, finally, a third input object may perform the second gesture. To avoid unnecessarily complicating the description, the singular form of input object is used and refers to all of the above variations.

The sensing region (120) encompasses any space above, around, in and/or near the input device (100) in which the input device (100) is able to detect user input (e.g., user input provided by one or more input objects). The sizes, shapes, and locations of particular sensing regions may vary widely from embodiment to embodiment.

In some embodiments, the sensing region (120) extends from a surface of the input device (100) in one or more directions into space until signal-to-noise ratios prevent sufficiently accurate object detection. The extension above the surface of the input device may be referred to as the above surface sensing region. The distance to which this sensing region (120) extends in a particular direction, in various embodiments, may be on the order of less than a millimeter, millimeters, centimeters, or more, and may vary significantly with the type of sensing technology used and the accuracy desired. Thus, some embodiments sense input that comprises no contact with any surfaces of the input device (100), contact with an input surface (e.g. a touch surface) of the input device (100), contact with an input surface of the input device (100) coupled with some amount of applied force or pressure, and/or a combination thereof. In various embodiments, input surfaces may be provided by surfaces of casings within which the sensor electrodes reside, by face sheets applied over the sensor electrodes or any casings, etc. In some embodiments, the sensing region (120) has a rectangular shape when projected onto an input surface of the input device (100).

The input device (100) may utilize any combination of sensor components and sensing technologies to detect user input in the sensing region (120). The input device (100) includes one or more sensing elements for detecting user input. As several non-limiting examples, the input device (100) may use capacitive, elastive, resistive, inductive, magnetic, acoustic, ultrasonic, and/or optical techniques.

Some implementations are configured to provide images that span one, two, three, or higher dimensional spaces. Some implementations are configured to provide projections of input along particular axes or planes. Further, some implementations may be configured to provide a combination of one or more images and one or more projections.

In some resistive implementations of the input device (100), a flexible and conductive first layer is separated by one or more spacer elements from a conductive second layer. During operation, one or more voltage gradients are created across the layers. Pressing the flexible first layer may deflect it sufficiently to create electrical contact between the layers, resulting in voltage outputs reflective of the point(s) of contact between the layers. These voltage outputs may be used to determine positional information.

In some inductive implementations of the input device (100), one or more sensing elements pick up loop currents induced by a resonating coil or pair of coils. Some combination of the magnitude, phase, and frequency of the currents may then be used to determine positional information.

In some capacitive implementations of the input device (100), voltage or current is applied to create an electric field. Nearby input objects cause changes in the electric field, and produce detectable changes in capacitive coupling that may be detected as changes in voltage, current, or the like.

Some capacitive implementations utilize arrays or other regular or irregular patterns of capacitive sensing elements to create electric fields. In some capacitive implementations, separate sensing elements may be ohmically shorted together to form larger sensor electrodes. Some capacitive implementations utilize resistive sheets, which may be uniformly resistive.

Some capacitive implementations utilize “self capacitance” (or “absolute capacitance”) sensing methods based on changes in the capacitive coupling between sensor electrodes and an input object. In various embodiments, an input object near the sensor electrodes alters the electric field near the sensor electrodes, thus changing the measured capacitive coupling. In one implementation, an absolute capacitance sensing method operates by modulating sensor electrodes with respect to a reference voltage (e.g., system ground), and by detecting the capacitive coupling between the sensor electrodes and input objects. The reference voltage may by a substantially constant voltage or a varying voltage and in various embodiments; the reference voltage may be system ground. Measurements acquired using absolute capacitance sensing methods may be referred to as absolute capacitive measurements.

Some capacitive implementations utilize “mutual capacitance” (or “trans capacitance”) sensing methods based on changes in the capacitive coupling between sensor electrodes. In various embodiments, an input object near the sensor electrodes alters the electric field between the sensor electrodes, thus changing the measured capacitive coupling. In one implementation, a mutual capacitance sensing method operates by detecting the capacitive coupling between one or more transmitter sensor electrodes (also “transmitter electrodes” or “transmitter”) and one or more receiver sensor electrodes (also “receiver electrodes” or “receiver”). Transmitter sensor electrodes may be modulated relative to a reference voltage (e.g., system ground) to transmit transmitter signals. Receiver sensor electrodes may be held substantially constant relative to the reference voltage to facilitate receipt of resulting signals. The reference voltage may by a substantially constant voltage and in various embodiments; the reference voltage may be system ground. In some embodiments, transmitter sensor electrodes may both be modulated. The transmitter electrodes are modulated relative to the receiver electrodes to transmit transmitter signals and to facilitate receipt of resulting signals. A resulting signal may include effect(s) corresponding to one or more transmitter signals, and/or to one or more sources of environmental interference (e.g. other electromagnetic signals). The effect(s) may be the transmitter signal, a change in the transmitter signal caused by one or more input objects and/or environmental interference, or other such effects. Sensor electrodes may be dedicated transmitters or receivers, or may be configured to both transmit and receive. Measurements acquired using mutual capacitance sensing methods may be referred to as mutual capacitance measurements.

Further, the sensor electrodes may be of varying shapes and/or sizes. The same shapes and/or sizes of sensor electrodes may or may not be in the same groups. For example, in some embodiments, receiver electrodes may be of the same shapes and/or sizes while, in other embodiments, receiver electrodes may be varying shapes and/or sizes.

In FIG. 1, a processing system (110) is shown as part of the input device (100). The processing system (110) is configured to operate the hardware of the input device (100) to detect input in the sensing region (120). The processing system (110) includes parts of or all of one or more integrated circuits (ICs) and/or other circuitry components. For example, a processing system for a mutual capacitance sensor device may include transmitter circuitry configured to transmit signals with transmitter sensor electrodes, and/or receiver circuitry configured to receive signals with receiver sensor electrodes. Further, a processing system for an absolute capacitance sensor device may include driver circuitry configured to drive absolute capacitance signals onto sensor electrodes, and/or receiver circuitry configured to receive signals with those sensor electrodes. In one more embodiments, a processing system for a combined mutual and absolute capacitance sensor device may include any combination of the above described mutual and absolute capacitance circuitry. In some embodiments, the processing system (110) also includes electronically-readable instructions, such as firmware code, software code, and/or the like. In some embodiments, components composing the processing system (110) are located together, such as near sensing element(s) of the input device (100). In other embodiments, components of processing system (110) are physically separate with one or more components close to the sensing element(s) of the input device (100), and one or more components elsewhere. For example, the input device (100) may be a peripheral coupled to a computing device, and the processing system (110) may include software configured to run on a central processing unit of the computing device and one or more ICs (perhaps with associated firmware) separate from the central processing unit. As another example, the input device (100) may be physically integrated in a mobile device, and the processing system (110) may include circuits and firmware that are part of a main processor of the mobile device. In some embodiments, the processing system (110) is dedicated to implementing the input device (100). In other embodiments, the processing system (110) also performs other functions, such as operating display screens, driving haptic actuators, etc.

The processing system (110) may be implemented as a set of modules that handle different functions of the processing system (110). Each module may include circuitry that is a part of the processing system (110), firmware, software, or a combination thereof. In various embodiments, different combinations of modules may be used. For example, as shown in FIG. 1, the processing system (110) may include a determination module (150) and a sensor module (160). The determination module (150) may include functionality to determine when at least one input object is in a sensing region, determine signal to noise ratio, determine positional information of an input object, identify a gesture, determine an action to perform based on the gesture, a combination of gestures or other information, and/or perform other operations.

The sensor module (160) may include functionality to drive the sensing elements to transmit transmitter signals and receive the resulting signals. For example, the sensor module (160) may include sensory circuitry that is coupled to the sensing elements. The sensor module (160) may include, for example, a transmitter module and a receiver module. The transmitter module may include transmitter circuitry that is coupled to a transmitting portion of the sensing elements. The receiver module may include receiver circuitry coupled to a receiving portion of the sensing elements and may include functionality to receive the resulting signals.

Although FIG. 1 shows a determination module (150) and a sensor module (160), alternative or additional modules may exist in accordance with one or more embodiments of the invention. Such alternative or additional modules may correspond to distinct modules or sub-modules than one or more of the modules discussed above. Example alternative or additional modules include hardware operation modules for operating hardware such as sensor electrodes and display screens, data processing modules for processing data such as sensor signals and positional information, reporting modules for reporting information, and identification modules configured to identify gestures, such as mode changing gestures, and mode changing modules for changing operation modes. Further, the various modules may be combined in separate integrated circuits. For example, a first module may be comprised at least partially within a first integrated circuit and a separate module may be comprised at least partially within a second integrated circuit. Further, portions of a single module may span multiple integrated circuits. In some embodiments, the processing system as a whole may perform the operations of the various modules.

In some embodiments, the processing system (110) responds to user input (or lack of user input) in the sensing region (120) directly by causing one or more actions. Example actions include changing operation modes, as well as graphical user interface (GUI) actions such as cursor movement, selection, menu navigation, and other functions. In some embodiments, the processing system (110) provides information about the input (or lack of input) to some part of the electronic system (e.g. to a central processing system of the electronic system that is separate from the processing system (110), if such a separate central processing system exists). In some embodiments, some part of the electronic system processes information received from the processing system (110) to act on user input, such as to facilitate a full range of actions, including mode changing actions and GUI actions.

For example, in some embodiments, the processing system (110) operates the sensing element(s) of the input device (100) to produce electrical signals indicative of input (or lack of input) in the sensing region (120). The processing system (110) may perform any appropriate amount of processing on the electrical signals in producing the information provided to the electronic system. For example, the processing system (110) may digitize analog electrical signals obtained from the sensor electrodes. As another example, the processing system (110) may perform filtering or other signal conditioning. As yet another example, the processing system (110) may subtract or otherwise account for a baseline, such that the information reflects a difference between the electrical signals and the baseline. As yet further examples, the processing system (110) may determine positional information, recognize inputs as commands, recognize handwriting, and the like.

“Positional information” as used herein broadly encompasses absolute position, relative position, velocity, acceleration, and other types of spatial information. Exemplary “zero-dimensional” positional information includes near/far or contact/no contact information. Exemplary “one-dimensional” positional information includes positions along an axis. Exemplary “two-dimensional” positional information includes motions in a plane. Exemplary “three-dimensional” positional information includes instantaneous or average velocities in space. Further examples include other representations of spatial information. Historical data regarding one or more types of positional information may also be determined and/or stored, including, for example, historical data that tracks position, motion, or instantaneous velocity over time.

In some embodiments, the input device (100) is implemented with additional input components that are operated by the processing system (110) or by some other processing system. These additional input components may provide redundant functionality for input in the sensing region (120), or some other functionality. FIG. 1 shows buttons (130) near the sensing region (120) that may be used to facilitate selection of items using the input device (100). Other types of additional input components include sliders, balls, wheels, switches, and the like. Conversely, in some embodiments, the input device (100) may be implemented with no other input components.

In some embodiments, the input device (100) includes a touch screen interface, and the sensing region (120) overlaps at least part of an active area of a display screen. For example, the input device (100) may include substantially transparent sensor electrodes overlaying the display screen and provide a touch screen interface for the associated electronic system. The display screen may be any type of dynamic display capable of displaying a visual interface to a user, and may include any type of light emitting diode (LED), organic LED (OLED), cathode ray tube (CRT), liquid crystal display (LCD), plasma, electroluminescence (EL), or other display technology. The input device (100) and the display screen may share physical elements. For example, some embodiments may utilize some of the same electrical components for displaying and sensing. In various embodiments, one or more display electrodes of a display device may configured for both display updating and input sensing. As another example, the display screen may be operated in part or in total by the processing system (110).

It should be understood that while many embodiments of the invention are described in the context of a fully functioning apparatus, the mechanisms of the present invention are capable of being distributed as a program product (e.g., software) in a variety of forms. For example, the mechanisms of the present invention may be implemented and distributed as a software program on information bearing media that are readable by electronic processors (e.g., non-transitory computer-readable and/or recordable/writable information bearing media that is readable by the processing system (110)). Additionally, the embodiments of the present invention apply equally regardless of the particular type of medium used to carry out the distribution. For example, software instructions in the form of computer readable program code to perform embodiments of the invention may be stored, in whole or in part, temporarily or permanently, on a non-transitory computer readable storage medium. Examples of non-transitory, electronically readable media include various discs, physical memory, memory, memory sticks, memory cards, memory modules, and or any other computer readable storage medium. Electronically readable media may be based on flash, optical, magnetic, holographic, or any other storage technology.

Although not shown in FIG. 1, the processing system, the input device, and/or the host system may include one or more computer processor(s), associated memory (e.g., random access memory (RAM), cache memory, flash memory, etc.), one or more storage device(s) (e.g., a hard disk, an optical drive such as a compact disk (CD) drive or digital versatile disk (DVD) drive, a flash memory stick, etc.), and numerous other elements and functionalities. The computer processor(s) may be an integrated circuit for processing instructions. For example, the computer processor(s) may be one or more cores, or micro-cores of a processor. Further, one or more elements of one or more embodiments may be located at a remote location and connected to the other elements over a network. Further, embodiments of the invention may be implemented on a distributed system having several nodes, where each portion of the invention may be located on a different node within the distributed system. In one embodiment of the invention, the node corresponds to a distinct computing device. Alternatively, the node may correspond to a computer processor with associated physical memory. The node may alternatively correspond to a computer processor or micro-core of a computer processor with shared memory and/or resources.

While FIG. 1 shows a configuration of components, other configurations may be used without departing from the scope of the invention. For example, various components may be combined to create a single component. As another example, the functionality performed by a single component may be performed by two or more components.

As discussed above, the active pen (140) is an example of an input object. The active pen (140) may have one or more features including button(s), display(s), a tip force sensor, batteries, various instruments to measure motion of the active pen (140), etc. Some of the features (e.g., buttons) may be selected/operated by the user of the active pen (140). Some of the features (e.g., displays) may be used to present information to the user of the active pen (140). Some of the features (e.g., instruments of measure motion, tip force sensor) may be used to collect data on how the user is handling the active pen (140).

In some embodiments, the active pen (140) is configured to assemble a set of bits. The set of bits may represent multiple concatenated fields, with each field storing a value corresponding to a feature (e.g., button, display, tip force sensor, etc.) or a custom value. For example, one field may store a value indicating that a button on the active pen (140) has been selected by the user. Another field may store a value indicating the force at the tip of the active pen (140) (i.e., whether the user is pressing the pen firmly or lightly against a surface). In some embodiments, the set always starts with a predefined starting sequence and/or includes error detecting or error correcting codes.

In one or more embodiments, the active pen (140) may assemble multiple different sets of bits. One set of bits may be assembled when the active pen (140) determines that it is in contact with a surface. This set of bits may be referred to as a contact packet. In one or more embodiments, a second set of bits may be assembled when the pen is in “hover mode,” meaning that the pen is in use but not touching a surface with the tip of the pen. In some embodiments, “hover mode” may comprise the active pen (140) being in the sensing region (120), but not in physical contact with a surface in the sensing region (120). The hover packet may be shorter than the contact packet. It will be apparent to one of ordinary skill in the art that there are many ways to assemble and organize data to be sent by the active pen (140) and, as such, the invention should not be limited to the above examples.

In one or more embodiments, the active pen (140) is configured to transmit sets of bits. Specifically, the active pen (140) may use the set of bits as a data signal to modulate a carrier signal(s), and then transmit the resulting modulated carrier signal(s). The same set of bits may be retransmitted over and over. For example, the active pen (140) may modulate a carrier signal accordingly to the frequency shift keying (FSK) modulation scheme. Other modulation schemes (e.g., Amplitude Shift Keying (ASK), Quadrature Amplitude Modulation (QAM), etc.) may also be used. In one or more embodiment, the set of bits are encoded (e.g., using the Manchester encoding scheme) prior to modulating the carrier signal(s).

In one or more embodiments, the input device system (100) includes one or more sensing elements to receive/intercept/detect RF waves. In other words, the sensing elements are effectively antennas. As discussed above, the received RF waves may correspond to signals transmitted by the active pen (140). Multiple sensor elements may receive the same modulated carrier signal but with different strengths. These various signal strengths and/or the data transmitted in the modulated carrier signal may be used to determine positional information.

Those skilled in the art, having the benefit of this detailed description, will appreciate that the type/content of data that is transmitted by the active pen (140), the encoding scheme used to encode the data, the modulation scheme used to transmit the data, the function of the buttons on the active pen (140), the messages presented on the display of the active pen (140), etc. are controlled, at least in part, by software executing on the active pen (140). This software may be initially installed by the manufacturer of the active pen (140). However, at a future time, there may be a need to update the software. For example, the manufacturer of the active pen (140) or a third-party may release an updated version of the software. Additionally or alternatively, a user may wish to install custom software on the active pen (140) and/or change an operating parameter of the active pen (140). Although the disclosed embodiments have used the term “software,” those skilled in the art, having the benefit of this detailed description, will appreciate that “software” includes firmware, binary code, machine code, and computing/programming code of any type in any format.

In one or more embodiments, the processing system (110) includes a reprogramming module (152) and one or more output devices (e.g., speaker (114), socket (118), display screen (155)). The reprogramming module (152) is configured to obtain reprogramming instructions for modifying the software executing on the active pen (140). For example, the reprogramming instructions may be downloaded from a website. As another example, the reprogramming instructions may be read from a flash drive (not shown) or other storage device connected to the reprogramming module (152). The reprogramming instructions may be intended to replace all of the software or only a code segment of the software executing on the active pen (140). One or more of the output devices (114, 118, 155) are configured to transmit the reprogramming instructions to the active pen (140). In one or more embodiments, the input device (100) may be referred to as a reprogramming device. In one or more embodiments, the reprogramming module (152) and the output device(s) (114, 118, 155) may be located on a device that is separate from the input device (100). This separate device may also be referred to as a reprogramming device.

In one or more embodiments, the input device (100) includes a speaker (114). The speaker (114) is configured to generate acoustic (i.e., pressure) waves based on the reprogramming instructions. Specifically, the acoustic waves are used to transmit the reprogramming instructions to the active pen (140) (discussed below).

In one or more embodiments, the input device (100) includes a socket (118). The socket (118) may be designed to accommodate an audio jack (e.g., ⅛″ audio jack, 1/16″ audio jack, etc.). The reprogramming module (152) may transmit the reprogramming instructions to the active pen (140) over an audio cable ending with an audio jack plugged in to the socket (118) (discussed below). In such scenarios, the reprogramming instructions may be used to modulate a carrier signal, and it is this modulated signal that is transmitted over the audio cable to the active pen (140). Various modulation schemes (e.g., Amplitude Shift Keying (ASK), Frequency Shift Keying (FSK), Quadrature Amplitude Modulation (QAM), etc.) may be used to generate the modulated signal. In one or more embodiments, the transmitted signal corresponds to a stereo audio signal, with the left channel and the right channel being used for different information. For example, one channel may encode data while the other channel may encode a clock. As another example, both channels may encode data effectively doubling the bit rate.

In one or more embodiments, the input device (100) includes a display screen (155). The display screen (155) may be a touchscreen. The display screen (155) may partially or fully overlap with the sensing region (120). The reprogramming module (152) may transmit the reprogramming instructions to the active pen (140) using light emitted by the display screen (155). For example, the display screen (155) may be modulated to in order to send binary information. In other words, the reprogramming module (152) may cause the display screen (155) to flash pulses of light in order to transmit the reprogramming instructions to the active pen (140). These pulses may be transmitted using one or more light levels (i.e., one or more intensities), one or more durations, and one or more colors. Different colors, different pulse durations, and/or different intensities may be used to encode different information (e.g., different bits or bit sequences). Additionally or alternatively to visible light, ultraviolet (UV) light and/or infrared (IR) may be used to transmit the reprogramming instructions.

In one or more embodiments, different portions of the display screen (155) may be simultaneously used to transmit different parts of the reprogramming instructions to the active pen (i.e., parallel communication). In one or more embodiments, only one portion of the display screen (155) is used to transmit the reprogramming instructions to the active pen (140). In such embodiments, the portion of the display screen (155) may be located directly below the active pen (140). For example, the display screen (155) may be divided into four quadrants and only the quadrant making contact with the active pen (140) (e.g., the user may be writing with the active pen) is used to transmit the reprogramming instructions. The remaining three quadrants may be used to display other material to the user while the one quadrant is transmitting the reprogramming instructions. In other embodiments, the reprogramming module (152) may be configured to transmit reprogramming instructions at the location of the active pen (140), and change the portion of the display that is transmitting reprogramming instructions as the active pen (140) moves relative to the display screen (155). For example, a small portion of the display screen may transmit reprogramming instructions, and the small portion that is transmitting may follow the active pen (140) as the active pen (140) moves across the screen. In this manner, the portion of the display that is used for transmitting reprogramming instructions is limited, while still successfully transmitting instructions even as the active pen (140) moves.

Although some output devices have been discussed (e.g., speaker (114), socket (118), and display screen (155)), those skilled in the art, having the benefit of this detailed description, will appreciate that the input device (100) may use antennae, fiber optics, and/or any other communication means to transmit the reprogramming instructions to the active pen (140).

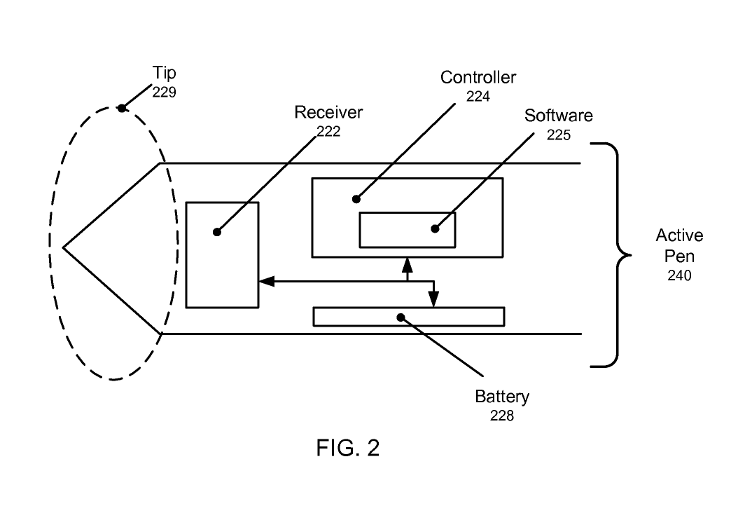

FIG. 2 shows a schematic diagram of an active pen (240) in accordance with one or more embodiments. The active pen (240) may correspond to active pen (140), discussed above in reference to FIG. 1. As shown in FIG. 2, the active pen (240) has multiple components including a receiver (222), a controller (224) storing and executing software (225), and a battery (228). As also shown in FIG. 2, the body of the active pen (240) includes/ends with a tip (229). Each of these components is discussed below.

In one or more embodiments of the invention, the active pen (240) includes the receiver (222). The receiver (222) is configured to receive the reprogramming instructions that are transmitted by the output device (e.g., speaker (114), socket (118), display screen (155)), discussed above in reference to FIG. 1. Accordingly, the receiver (222) may include one or more sensors that interface with and/or detect the transmitted reprogramming instructions.

For example, in the case of acoustic waves, the sensor(s) may be a force gauge and/or a microphone that is actuated by the acoustic waves. The tip (229) of the active pen (240) may need to be placed against the speaker (114) for the transmission to take place. As another example, in the case of electromagnetic signals over an audio cable, the sensor(s) may be a socket for an audio jack (e.g., ⅛″ audio jack, 1/16″ audio jack, etc.). As yet another example, in the case of light emitted from the display screen (155), the sensor(s) may be a photo-receiver or other optical detector (e.g., photo-diode, photo-transistor, photo cell, etc.) which generates an electrical signal that is a function of the detected light. The one or more sensors may be placed along the body of the active pen (240). Additionally or alternatively, the one or more sensors may be placed within the tip (229) of the active pen (240). In one or more embodiments, the sensor(s) is a light emitting diode (LED) on the exterior of the active pen (240) that was previously used as an indicator and has been repurposed to act as an optical detector.

In one or more embodiments of the invention, the receiver (222) includes circuitry and/or circuit components (e.g., analog-to-digital (A/D) converters, comparators, amplifiers, decoders, error correction code (ECC) blocks, etc.) to extract (e.g., demodulate, decode, etc.) the reprogramming instructions from the format in which the reprogramming instructions were transmitted. Although the receiver (222) is shown as a single block in FIG. 2, the receiver (222) may be composed of multiple blocks scattered within the active pen (240).

In one or more embodiments, the active pen (240) includes the controller (224). The controller (224) is a processor or micro-processor that executes the software (225). As discussed above, the type/content of data that is transmitted by the active pen (240), the modulation scheme used to transmit the data, the function of the buttons (not shown) on the active pen, etc., are controlled, at least in part, by the software (225). In one or more embodiments of the invention, the controller (224) is configured to modify the software (225) based on the reprogramming instructions. Modifying the software (225) may include replacing a portion or all of the software (225) with replacement code. The replacement code may be transmitted as part of the reprogramming instructions. Additionally or alternatively, the replacement code may already be stored within the active pen (240) and the reprogramming instructions identify the replacement code but do not include the replacement code. Modifying the software (225) may include changing one or more operating parameters of the active pen (240) (e.g., frequency at which the active pen transmits signals, output power of the transmitted signals, etc.).

In one or more embodiments, the active pen (240) includes a battery (228). The battery (228) provides electrical power to other components of the active pen (240). In one or more embodiments of the invention, the battery (228) may be recharged using low frequency currents received by the receiver (222) (discussed below).

In one or more embodiments, the active pen (240) operates in two modes: normal mode and reprogramming mode. The default mode may be normal mode. During normal mode, the software (225) is being executed and the active pen (240) is operating as dictated by the software (225). In reprogramming mode, the active pen (240) is obtaining reprogramming instructions and replacing some or all of software (225). There may be one or more events that trigger a switch between the operating modes of the active pen (240) (e.g., from normal mode to reprogramming mode).

For example, user interaction with buttons on the pen (e.g., a specific button sequence) and/or other sensors on the pen (e.g., force gauge) may trigger the switch to reprogramming mode. As another example, if the receiver (222) includes a socket, insertion of an audio jack into the socket may trigger the switch to reprogramming mode. As another example, if the receiver (222) includes a photo-receiver, removing (e.g., sliding or retracting) a cover/gate that normally shields the photo-receiver from stray light may trigger the switch to reprogramming mode. Additionally or alternatively, detecting high-light levels emitted by the display screen (155) may be used to trigger the switch to reprogramming mode. As yet another example, the state of the buttons when the active pen is turned on and/or when the battery (228) is installed may be used to trigger the switch.

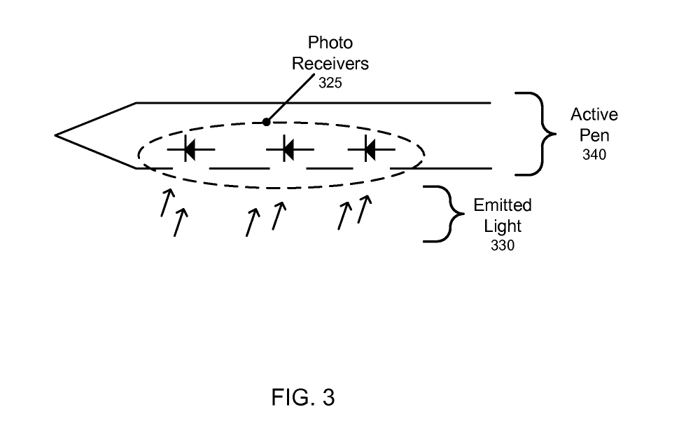

FIG. 3 shows an active pen (340) in accordance with one or more embodiments. The active pen (340) may be essentially the same as active pen (140) and active pen (240), discussed above in reference to FIG. 1 and FIG. 2, respectively. As shown in FIG. 3, the active pen (340) includes multiple photo-receivers (325) to receive the transmitted reprogramming instructions. In other words, the receiver (not shown) in the active pen (340) uses photo-receivers (325) to detect/interface with the emitted light (330) that encodes the reprogramming instructions. The multiple photo-detectors may be used to detect multiple colors and/or multiple intensities at multiple positions (e.g., light emitted from multiple locations of the display screen (155)). Although not shown, windows may exist between the photo-receivers (325) and the environment in which the active pen (340) is located. There may also be gates for blocking the windows when the active pen (340) is not in reprogramming mode. In other embodiments, the photo receivers may be located at or near the tip of the active pen (340) or near the rear end of the active pen (340).

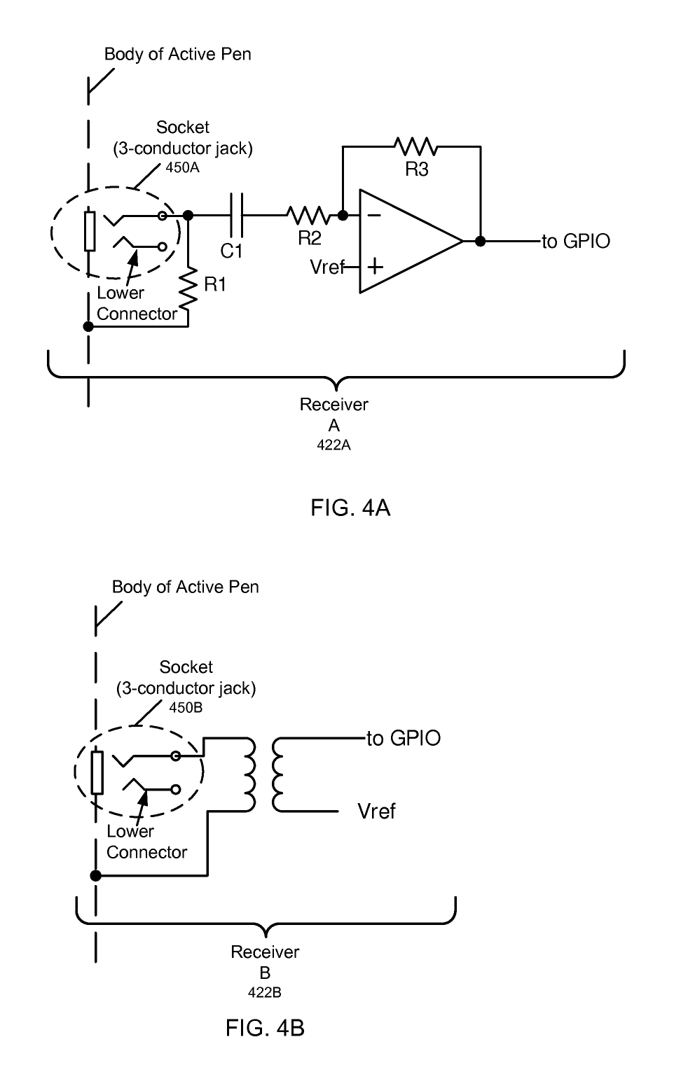

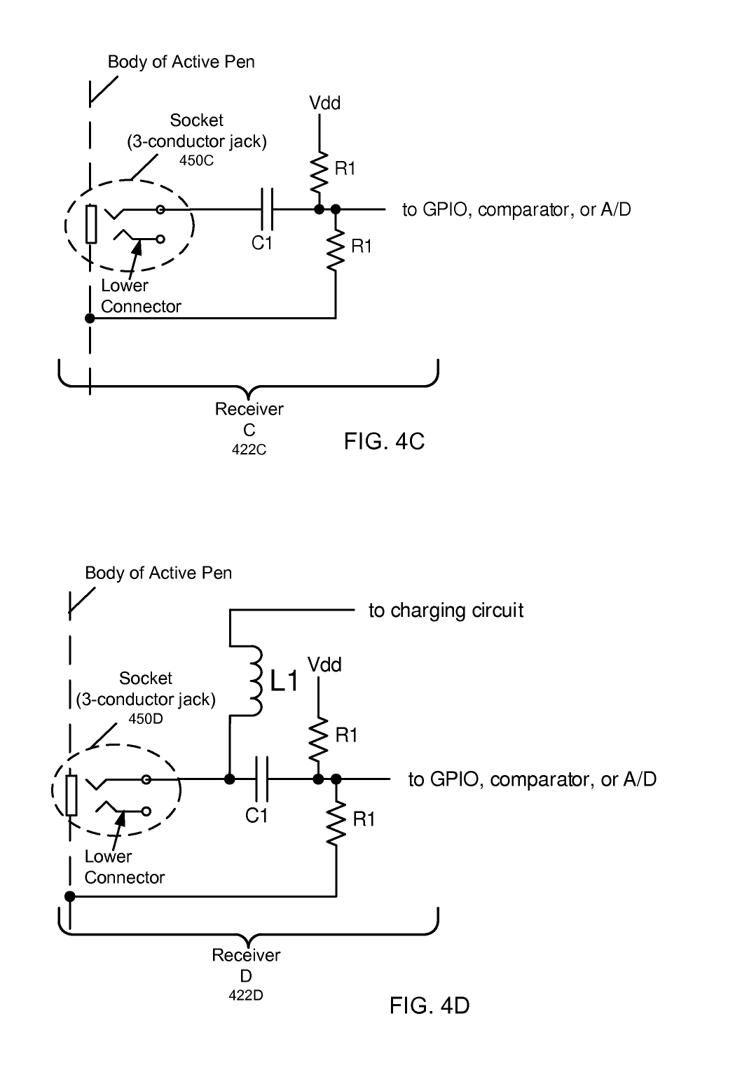

FIGS. 4A-4D show partial circuit diagrams for different receivers (Receiver A (422A), Receiver B (422B), Receiver C (422C), and Receiver D (422D)) in accordance with one or more embodiments. Each receiver (422A, 422B, 422C, 422D) may correspond to receiver (222), discussed above in reference to FIG. 2. These example receivers (422A, 422B, 422C, 422D) may be used when the reprogramming instructions are transmitted to the active pen across an audio cable terminating in audio jacks. As shown in FIGS. 4A-4D, each receiver (422A, 422B, 422C, 422D) includes a socket (450A, 450B, 450C, 450D) for a 3-conductor jack (e.g., ⅛″ audio jack). In one or more embodiments, the lower connector within the socket (450A, 450B, 450C, 450D) is the second audio terminal. Alternatively, the lower connector within the socket (450A, 450B, 450C, 450D) is ground and thus the lower connector is connected to the body of the active pen (not shown). Those skilled in the art, having the benefit of this detailed description, will appreciate that the circuitry shown for each receiver (422A, 422B, 422C, 422D) is used to condition the incoming signal such that the additional circuit components (e.g., analog-to-digital converter, comparators, general purpose input/output (GPIO) circuitry, etc.) (not shown) are able to extract the reprogramming instructions from the signal.

In FIG. 4A, the incoming signal is AC coupled and then amplified. The output of the amplification feeds into GPIO circuitry for decoding.

FIG. 4B shows transformer coupled signal conditioning. Other than the reference voltage Vref (which may be 0.5Vdd), the conditioning circuitry is passive. Since the peak-to-peak voltages from an audio signal are approximately 1 Vpp, a 1:3 turns ratio transformer will result in approximately 3Vpp, which could be decoded by a GPIO.

In FIG. 4C, the incoming signal is AC coupled into a voltage divider, which feeds into a GPIO. If the signals are not large enough, a comparator or A/D converter may be used. If an A/D converter is used, more complex coding schemes (e.g., QAM) may be used to transmit the reprogramming instructions.

FIG. 4D is similar to FIG. 4C, except that an inductor has been added. The inductor acts as a low pass filter to send low frequency currents to a charging circuit to charge the battery (228) of the active pen. These low frequency currents may be part of the incoming signal (i.e., the signal which also includes the reprogramming instructions). Additionally or alternatively, a DC power supply may be connected to the socket (450D) to charge the battery. The inductor ensures that the audio signal is not loaded by the charging circuit. In one or more embodiments, the active pen includes a micro-USB connector on it (not shown) for recharging. A micro-USB to ⅛″ plug adapter could then be used for reprogramming. Alternatively, the active pen could have a ⅛″ jack and a ⅛″ plug to USB-A cable would be used for recharging.

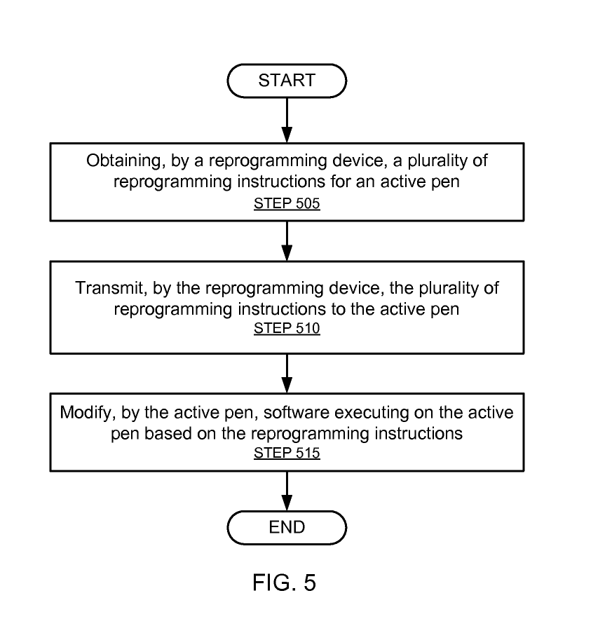

FIG. 5 shows a flowchart in accordance with one or more embodiments of the invention. The flowchart depicts a process for reprogramming an active pen. One or more of the steps in FIG. 5 may be performed by the components of the input device (100), discussed above in reference to FIG. 1. In one or more embodiments of the invention, one or more of the steps shown in FIG. 5 may be omitted, repeated, and/or performed in a different order than the order shown in FIG. 5. Accordingly, the scope of the invention should not be considered limited to the specific arrangement of steps shown in FIG. 5.

Initially, reprogramming instructions are obtained (Step 505). The reprogramming instructions may be obtained by a reprogramming device (e.g., input device (100), discussed above in reference to FIG. 1). The reprogramming instructions may be downloaded from a website or read from a storage device. The reprogramming instructions may include code to replace all or part of software (e.g., firmware) executing on and controlling an active pen (e.g., active pen (140)). Additionally or alternatively, the reprogramming instructions include directives to change the operating parameters of the active pen, but might not have replacement code.

In Step 510, the reprogramming instructions are transmitted from the reprogramming device to the active pen. Specifically, the reprogramming device may have one or more output devices (e.g., socket for an audio jack, display device, speaker, etc.) for transmitting the reprogramming instructions to the active pen. Accordingly, the reprogramming instructions may be transmitted over an audio cable, using light emitted from a display device, using acoustic waves generated by a speaker, etc. The active pen has the necessary sensor(s) (e.g., force gauge, microphone, photo-detectors, socket for audio jack) and circuitry to interface/detect the reprogramming instructions being transmitted by the reprogramming device and decode the reprogramming instructions.

In Step 515, the active pen modifies the software (e.g., firmware) based on the reprogramming instructions. As discuss above, this may include replacing all or part of the software with replacement code that is either included with the reprogramming instructions and/or stored separately and identified by the reprogramming instructions. Additionally or alternatively, modifying the software may include changing one or more operating parameters of the active pen.

Various embodiments of the invention may include one or more of the following advantages: the ability to reprogram an active pen without bringing a pin of the active pen's controller to the exterior of the active pen; the ability to reprogram an active pen with an easily replaceable audio cable; the ability to reprogram the active pen using the light of a display screen; the ability to reprogram the active pen using light having different intensities, different colors, and/or different pulse durations; the ability to reprogram an active pen having a microphone or force gauge using acoustic waves; etc.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. An active pen, comprising:
a receiver configured to obtain a plurality of a reprogramming instructions from a reprogramming device; and
a controller configured to modify software of the active pen based on the plurality of reprogramming instructions.

2. The active pen of claim 1, wherein the reprogramming device comprises a speaker configured to generate an acoustic wave based on the plurality of reprogramming instructions, and wherein receiver comprises a force gauge that is actuated by the acoustic wave.

3. The active pen of claim 2, wherein the force gauge is in a tip of the active pen and the tip is held against the speaker.

4. The active pen of claim 1, wherein the receiver comprises a socket for an audio jack, and wherein the plurality of reprogramming instructions are transmitted from the reprogramming device over an audio cable to the audio jack plugged into the socket.

5. The active pen of claim 4, wherein the audio jack is a ⅛″ audio jack.

6. The active pen of claim 4, wherein the plurality of reprogramming instructions are transmitted using a stereo audio signal having a left channel and a right channel, and wherein the left channel and the right channel are utilized to encode different information.

7. The active pen of claim 4, further comprising:
a battery; and
a recharging circuit configured to recharge the battery using low frequency currents obtained by the receiver.

8. The active pen of claim 1, wherein the receiver comprises a photo-receiver, and wherein the reprogramming device comprises a display screen configured to emit light based on the plurality of reprogramming instructions.

9. The active pen of claim 8, wherein the light comprises a plurality of colors, and wherein different colors are utilized to encode different information.

10. The active pen of claim 8, wherein the light comprises a plurality of brightness levels, and wherein different brightness levels are utilized to encode different information.

11. The active pen of claim 8, wherein the photo-receiver is located on a tip of the active pen, and wherein the plurality of reprogramming instructions is received while the active pen is used for writing.

12. A reprogramming device for reprogramming an active pen, comprising:
a reprogramming module configured to obtain a plurality of reprogramming instructions for the active pen; and
an output device configured to transmit the plurality of reprogramming instructions to the active pen to modify software of the active pen.

13. The reprogramming device of claim 12, wherein the output device is a speaker, wherein the plurality of reprogramming instructions are transmitted using an acoustic wave generated by the speaker, and wherein the acoustic wave actuates a force gauge in the active pen.

14. The reprogramming device of claim 12, wherein the plurality of reprogramming instructions are transmitted over an audio cable ending in an audio jack plugged into a socket of the active pen.

15. The reprogramming device of claim 12, wherein the output device is a display screen, wherein the plurality of instructions are transmitted using light emitted by the display screen, and wherein the light is detected by a photo-receiver of the active pen.

16. The reprogramming device of claim 15, wherein the reprogramming device is configured to identify a portion of the display screen below the active pen, and wherein the light for transmitting the reprogramming instructions is emitted only from the portion of the display screen.

17. A method of reprogramming an active pen, comprising:
obtaining, by a reprogramming device, a plurality of reprogramming instructions; and
transmitting, by the reprogramming device, the plurality of instructions to the active pen,
wherein the plurality of instructions are received by a sensor on the active pen, and
wherein the plurality of instructions modify software of the active pen.

18. The method of claim 17, wherein the sensor is a socket for an audio jack, and wherein the plurality of reprogramming instructions are transmitted from the reprogramming device over an audio cable ending in the audio jack plugged into the socket.

19. The method of claim 17, wherein the sensor is a force gauge located in a tip of the active pen, and wherein the plurality of reprogramming instructions are transmitted using an acoustic wave generated by a speaker of the reprogramming device.

20. The method of claim 17, wherein the sensor is a photo-receiver, and wherein the plurality of reprogramming instructions are transmitted using light emitted from a display screen of the reprogramming device.
